(19) United States
(12) Patent Application Publication
(10) Pub. No.: US 2016/0297694 A1
(43) Pub. Date: Oct. 13, 2016

(54) HYBRID VAPOR COMPRESSION MEMBRANE DISTILLATION DRIVE ASSEMBLYAND METHOD OF USE

(71) Applicant: General Electric Company, Schenectady, NY (US)

(72) Inventors: Ricardo Hernandez Pereira, Sao Carlos (BR); Jens Ruetten, Munchen (DE); Bernardo Alves Cinelli, Rio de Janeiro (BR); Ana Carolina Miranda Costa, Rio de Janeiro (BR)

(21) Appl. No.: 14/680,260

(22) Filed: Apr. 7, 2015

(51) Int. Cl. C02F 1/44; B01D 61/36

(52) U.S. Cl. CPC C02F 1/447; B01D 61/364; B01D 61/366; B01D 61/368; C02F 2101/10

(57) ABSTRACT

A membrane distillation drive assembly including a vapor compressor, a steam expander and a prime mover, wherein a total vapor compressor load is shared between the steam expander and the prime mover. The membrane distillation drive assembly configured for driving a membrane distillation system further comprising a MD module disposed within an object and configured to receive an input feed stream and produce an output product flow stream. The vapor compressor configured to receive an input flow of low pressure steam and produce a compressed output flow, the steam expander configured to receive an input flow of high pressure steam and produce an expanded output flow. The compressed output flow and the expanded output flow provide an output flow of intermediate pressure steam to the MD module. The prime mover is coupled to the vapor compressor by one of a mechanical or electrical coupling.

### BACKGROUND

The present disclosure relates generally to membrane distillation technology. More particularly, this disclosure relates to membrane distillation systems and a novel vapor compression drive assembly for a membrane distillation system.

Membrane distillation (MD) is a thermally driven separation process that may commonly be employed to de-ionize or desalt a water source. In addition, membrane distillation may be used during the processing of foods, the removal of organic materials from water sources and also, but not limited to, the production processes of ethanol, cellulosic ethanol, farnesene and various bio-chemicals, such as butanol or the like. The premise behind membrane distillation is a vapor pressure difference induced by a temperature gradient created across a microporous membrane that separates vapor-liquid/liquid-liquid phases in equilibrium. Of particular interest in the membrane distillation process as an emerging technology is the means by which the vapor pressure difference is driven, and more particularly the driving of vapor compression to provide the vapor pressure difference across the microporous membrane.

In thermal desalination applications, the main design paradigm is the reuse of the latent heat of evaporation of the water, as this represents the major part of the total energy consumption. Two basic approaches are commonly used, the first one being the separation of a system into multiple stages at successively lower temperature and vapor pressures, the second option is the recompression of vapor generated in the system and feeding that vapor back into a higher temperature and pressure level of the system where it can be condensed and the latent heat recovered.

Known membrane distillation systems utilize waste heat to drive the vapor recompression in the system. A commonly used vapor recompression process is thermal vapor compression, in which a motive steam of high pressure is injected into a suction chamber. The pressure energy of the motive fluid is thus converted into kinetic energy (dynamic head), creating a low (static) pressure in the injection chamber and thus entraining the secondary fluid present in that chamber. The combined mass flow of both streams is then ejected at a pressure higher than that of the entrained fluid. The compression ratio that can be achieved depends on the ratio of the mass flows and pressures of the motive steam and the entrained low pressure steam.

The productivity of a purely waste heat (steam at about 100° C.) driven membrane distillation system is limited by the mass flow of primary steam and the number of stages of the MD subsystem, i.e. for given amount of supplied steam, the maximum theoretical distillate mass yield is related to the number of stages, thermal losses and the salinity dependent boiling point rise.

In one application of membrane distillation, steam boilers may be available and often used for various purposes, such as process heating and mechanical drive of machinery and electrical generators. In this scenario, steam availability for any additional use, such as by the membrane distillation system, may suffer wide variations throughout the day, as a result of the instantaneous steam demand of known system equipment. When steam demand for the known system equipment happens to occur simultaneously with the desire to utilize membrane distillation technology, very little extra steam may be available for driving the vapor compression required for the membrane distillation system. In the alternative, during periods of operation when demand for steam is reduced and steam boiler capacity is not fully employed, the boiler may be maintained at a higher load, supplying steam to drive the membrane distillation system.

In other applications of membrane distillation, energy from various different energy sources, such as electricity and fuel for steam production, may be available for driving the vapor compression required for the operation of membrane distillation. If the cost of those energy sources vary over time it may be economically advantageous, to reduce system operational costs, to alternate between energy sources as rates oscillate.

Therefore, there is a need for a new and improved membrane distillation drive assembly and method of driving a membrane distillation system that enables the distribution of a membrane compressor load between components to supply the compressor load in ways that better suit overall system energy usage.

### BRIEF SUMMARY

In an embodiment, a hybrid vapor compression membrane distillation drive assembly is provided in accordance with an embodiment. The hybrid vapor compression membrane distillation drive assembly comprises a vapor compressor, a steam expander and a prime mover coupled to the vapor compressor. The vapor compressor is configured to receive an input flow of low pressure steam and produce a compressed output flow. The steam expander is configured to receive an input flow of high pressure steam, having a pressure greater than the low pressure steam, and produce an expanded output flow. The compressed output flow and the expanded output flow provide an output flow of intermediate pressure steam. In the assembly, total vapor compressor load is shared between the steam expander and the prime mover.

In an alternate embodiment, a membrane distillation system is provided in accordance with another embodiment. The membrane distillation system comprises a membrane distillation module and a hybrid vapor compression drive assembly in fluidic communication with the membrane distillation module. The hybrid vapor compression drive assembly is configured to introduce an intermediate pressure steam to a high temperature side of the membrane distillation module and extract a low pressure steam, having a pressure less than the intermediate pressure steam, from a low temperature side of the membrane distillation module, thereby creating a temperature gradient across of the membrane distillation module. The hybrid vapor compression drive assembly comprising a vapor compressor, a steam expander and a prime mover coupled to the vapor compressor. The vapor compressor is configured to receive an input flow of low pressure steam and produce a compressed output flow. The steam expander is configured to receive an input flow of high pressure steam, having a pressure greater than the low pressure steam, and produce an expanded output flow. The compressed output flow and the expanded output flow provide an output flow of intermediate pressure steam. In the assembly, total vapor compressor load is shared between the steam expander and the prime mover.

In an alternate embodiment, a method of driving a membrane distillation system is provided in accordance with another embodiment. The method comprises supplying an unpurified fluid in an input feed stream; providing a membrane distillation module disposed within an object and configured to receive the input feed stream and produce an output product flow stream; supplying a hybrid vapor compression membrane distillation drive assembly in fluidic communication with the membrane distillation module, the hybrid vapor compression membrane distillation drive assembly comprising a vapor compressor configured to receive an input flow of low pressure steam from a low temperature side of the membrane distillation module, a steam expander configured to receive an input flow of high pressure steam, having a pressure greater than the low pressure steam, and a prime mover coupled to the vapor compressor; passing the input feed stream through the membrane distillation module as a flow stream while withdrawing the low pressure steam; at least one of compressing the withdrawn low pressure steam in a vapor compressor of the hybrid vapor compression membrane distillation drive assembly to produce a compressed output flow and expanding an input high pressure steam in a steam expander of the hybrid vapor compression membrane distillation drive assembly, wherein the input high pressure steam is of a pressure greater than the low pressure steam, to produce an expanded output flow, wherein the compressed output flow and the expanded output flow provide an output flow of intermediate pressure steam having a higher pressure than the withdrawn low pressure steam; and introducing the intermediate pressure steam to a high temperature side of the membrane distillation module, thereby creating a temperature gradient across of the MD module. The total power input (load) to the vapor compressor of the hybrid vapor compression membrane distillation drive assembly is shared between the steam expander and the prime mover.

These and other advantages and features will be better understood from the following detailed description of preferred embodiments of the invention that is provided in connection with the accompanying drawings.

### BRIEF DESCRIPTION OF THE DRAWINGS

FIG. 1 is a schematic diagram of a membrane distillation system including a hybrid vapor compression membrane distillation drive assembly in accordance with an exemplary embodiment;

FIG. 2 is a schematic diagram of a hybrid vapor compression membrane distillation drive assembly in accordance with an exemplary embodiment;

FIG. 3 is a schematic diagram of a hybrid vapor compression membrane distillation drive assembly in accordance with an exemplary embodiment;

FIG. 4 is a schematic diagram of a hybrid vapor compression membrane distillation drive assembly in accordance with an exemplary embodiment; and

FIG. 5 is a schematic diagram of a hybrid vapor compression membrane distillation drive assembly in accordance with an exemplary embodiment.

### DETAILED DESCRIPTION

Preferred embodiments of the present disclosure will be described here in below with reference to the accompanying drawings. In the following description, well-known functions or constructions are not described in detail to avoid obscuring the disclosure in unnecessary detail.

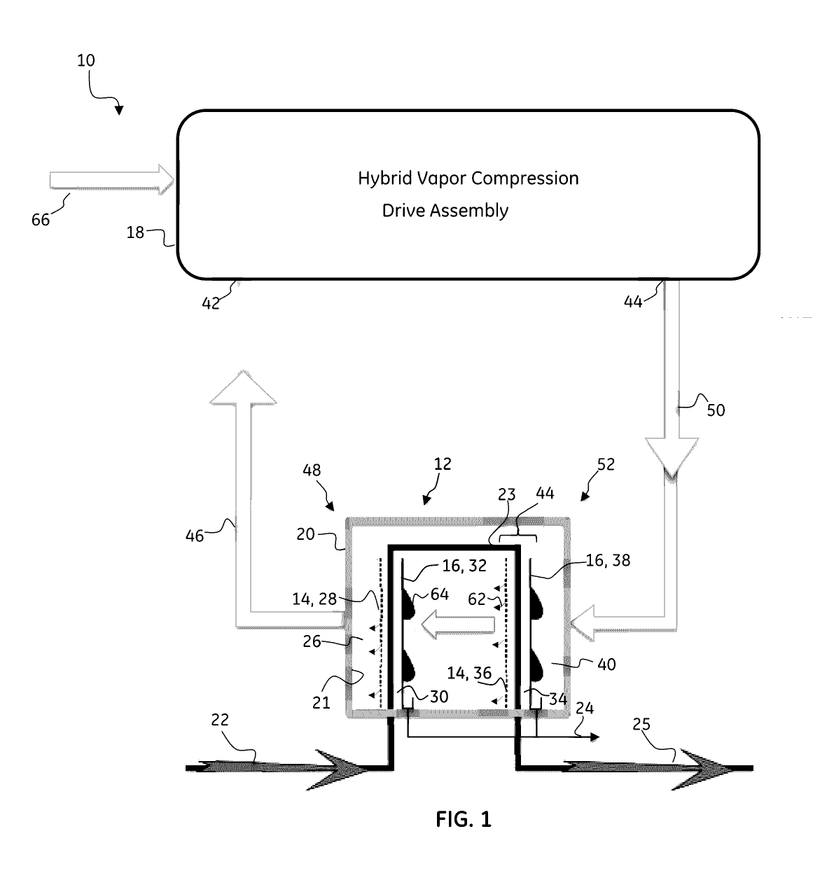

FIG. 1 is a schematic diagram of an exemplary membrane distillation system 10 including a hybrid vapor compression drive assembly in accordance with an exemplary embodiment. For the illustrated example, the membrane distillation system 10 comprises a membrane distillation (MD) module 12 including a plurality of MD membranes 14 and a plurality of heat transfer films 16 arranged in alternating or interleaved configuration. The membrane distillation system 10 further includes a hybrid vapor compression drive assembly 18 in fluidic communication therewith. The use of a hybrid vapor compression drive assembly 18 provides a promising alternative to purely sensible heat driven multi effect membrane distillation, as it is capable of utilizing higher grade heat sources to generate low mass flow/high pressure motive steam to drive the evaporation process within the MD module 12. In this configuration, the membrane distillation process can make use of the (waste) heat source in combination with a mechanical/electrical device for driving the process in order to achieve a higher performance by recompression of the steam generated in the final effect of the MD module(s), at the expense of a suitable available energy source required for driving the distillation process.

In exemplary embodiments, the MD module 12 is disposed within an object, such as a plate and frame assembly, or the like, and configured to receive an input feed stream 22 of an unpurified liquid having undesirable substances, such as salts or other solutes, dissolved gasses, organic compounds, or other impurities from a liquid feed source (not shown). When used for desalination, the input feed stream 22 may be seawater or brackish water. While the liquid feed source has not been shown herein, it is anticipated that the source may be a tank, or any other suitable liquid feed source such as a feed stream from another system or an intake in communication with a feed source, such as a body of water, such as an ocean or lake. An output stream 25, such as brine, is illustrated and may be configured for circulation back into the input feed stream 22 or feed into additional MD modules downstream. The membrane distillation system 10 produces an output product flow stream (a product stream) 24, which may be a dilute liquid coming out of the MD module 12, and may have a lower concentration of the undesirable species as compared to the input feed stream 22. In some examples, the output product flow stream 24 may be circulated into additional MD modules for further distillation. Additional information regarding the operation of the MD module 12 and example configurations are described in commonly assigned, U.S. Pat. No. 8,512,567, Andrew P. Shapiro, “Vapor Compression Membrane Distillation System and Method”, which is incorporated by reference herein in its entirety.

In the exemplary embodiment, the MD module 12 is disposed within the tank 20 in a manner that provides for the inflow and outflow of the flow stream 23 via input feed stream 22 and the output stream 25 and the production of the output product flow stream 24. The MD module 12 is configured to include a plurality of liquid flow channels and vapor flow channels therein. In an embodiment, a first extreme vapor flow channel 26 is formed between and bounded by a sidewall 21 of the tank 20 and a first MD membrane 28. A first liquid flow channel 30 is formed between and bounded by the first MD membrane 28 and a first heat transfer film 32. A second liquid flow channel 34 is formed between and bounded by a second MD membrane 36 and a second heat transfer film 38. A second extreme vapor flow channel 40 is formed between and bounded by the second heat transfer film 38 and the sidewall 21 of the tank 20. The interleaved membranes 28, 36 and films 32, 38 form the MD module 12.

As previously indicated, the membrane module 12 is driven by the hybrid vapor compression drive assembly 18. In an embodiment, an inlet 42 of the hybrid vapor compression drive assembly 18 is coupled to the first extreme vapor channel 26 and an outlet 44 of the hybrid vapor compression drive assembly 18 is coupled to the second extreme vapor channel 40. The coupling of the hybrid vapor compression drive assembly 18 and the channels 26 and 40 provides for the introduction of hot steam at an intermediate pressure to one side (hot) of the MD module 12 and cooler steam at a low pressure to be withdrawn from the other side (cool) of the MD module 12. As used herein the terms “low pressure steam”, “high pressure steam” and “intermediate pressure steam” are intended to describe the relationship between each of the flows of steam. Typically, for water desalinization applications, the low pressure steam withdrawn at the cool side of the MD module includes steam having an absolute pressure of about 1-50 kPa. Likewise, a high pressure steam input into the hybrid vapor compression drive assembly 18 and described presently, includes steam having an absolute pressure typically in the range of 75-300 kPa. The intermediate pressure steam input at the hot side of the MD module 12 includes steam having a pressure between that of the high pressure and low pressure steam inputs.

During the distillation process, a liquid, such as the input feed stream 22 is passed through the MD module 12 as indicated by flow stream 23, and the distilled product exits the MD module 12 as the output product flow stream 24. More specifically, in an embodiment a liquid to be desalinated is introduced via the input feed stream 22 to the first liquid flow channel 30 formed between the MD membrane 28 and the heat transfer film 32. The MD module 12 can be constructed so that the flow stream 23 is countercurrent to the direction of vapor and heat transport within the channels 26, 30, 34, 40 as illustrated in FIG. 1. Alternatively, the flow stream 23 can flow in parallel through the several liquid flow channels in each MD module 12.

In the embodiment illustrated in FIG. 1, two repeat MD pairings 44, each comprised of a single MD membrane 14 and a heat transfer film 16 form the MD module 12 and achieves desalination. It should be understood that it is anticipated that any number of MD pairings 44 may be used to form the MD module 12, and that the embodiment of FIG. 1 is illustrative only and not intended to be limiting.

During the distillation process, the hybrid vapor compression drive assembly 18 compresses an input flow of low pressure steam 46 from a low temperature side 48 of the MD module 12 and an input flow of high pressure steam 66. Compression of the input flow of low pressure steam 46 causes a rise in temperature and in combination with the input flow of high pressure steam 66, forms output flow of intermediate pressure steam 50 having a temperature and pressure greater than a temperature and pressure of the input flow of low pressure steam 46. The output flow of intermediate pressure steam 50 is introduced to a high temperature side 52 of the MD module 12. In this way, there is a temperature gradient across of the MD module 12. This temperature gradient causes progressively lower vapor pressures in the vapor flow channels 40 and 26 from the hot side 52 to the cold side 48 of the MD module 12. The lower vapor pressures on the cold side 48 of each of the MD membranes 28, 36 drives a water vapor 62 flux through the MD membranes 28, 36. In each repeat pairing 44 the water vapor 62 that passes through the MD membranes 28, 36 is condensed forming condensation 64 and collected as product water via output product flow stream 24. Depending on the vapor compression ratio and the number of repeat pairings 44 in the MD module 12, different temperature and vapor pressure drops across the MD module 12 can be maintained. In general, the more repeat pairings 44 and higher the fraction of latent heat of condensation that is transferred directly to evaporation, the higher the thermal efficiency will be. For one mass unit of vapor compressed it is reasonable to expect 3-10 units of product in the form of pure water to be produced.

In conventional membrane distillation configurations, the latent heat of condensed water is transferred to the sensible heat of a feed stream to achieve high thermal efficiency. This conventional process is limited in that the ratio of latent heat of water to the specific heat of water forces the mass flow of the condensed stream to be much less than the mass flow of the liquid stream that absorbs the latent heat. In the disclosed embodiment, the latent heat of condensation is transferred directly to the latent heat of vaporization. In this way the mass flows of the output product flow stream 24 (condensing) and the input feed stream 22 can be of the same order of magnitude. This simplifies the system design and enables the construction of high efficiency MD modules.

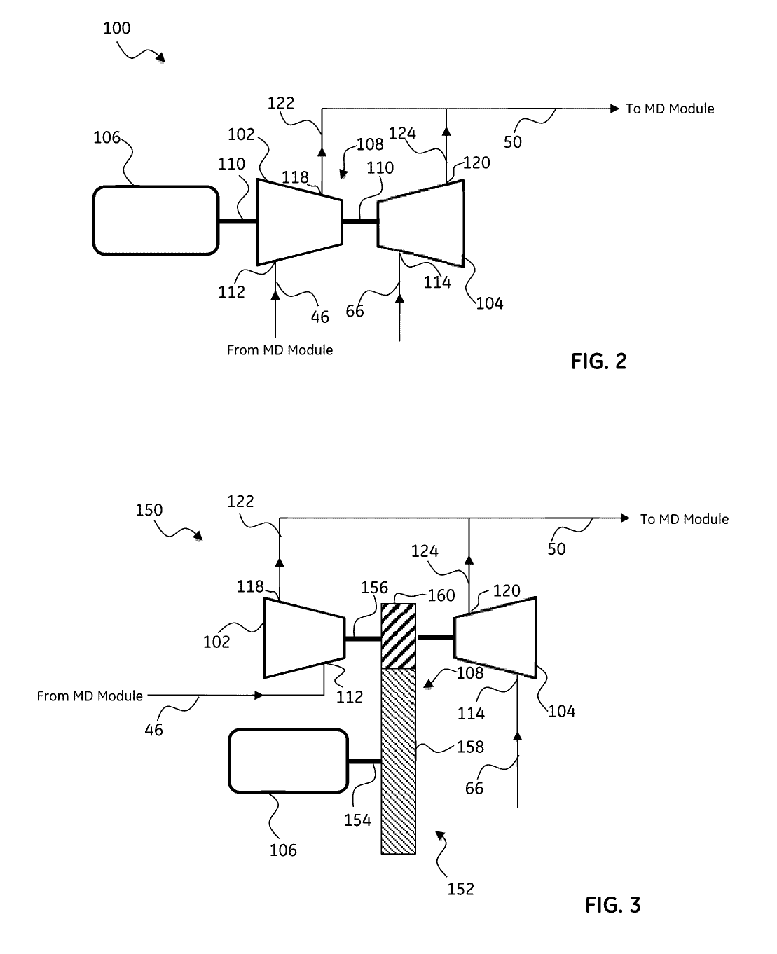

Referring now to FIGS. 2-5, illustrated in schematic diagrams are a plurality of configurations for the hybrid vapor compression drive assembly 18 of FIG. 1 as disclosed herein. Similar numerals are used throughout FIGS. 2-5 to indicate similar elements. In the disclosed embodiments of FIGS. 2-5, distillation vapor compression is driven simultaneously by an external prime mover (described presently), such as an electric motor, or the like, and the use of high pressure steam, such as the input flow of high pressure steam 66 of FIG. 1. More particularly, in each of the disclosed embodiments, the hybrid vapor compression drive assembly is configured whereby a vapor compressor load is split between a steam expander and a prime mover, such as an electrical motor, or the like.

In installations that use high pressure steam for other purposes the membrane distillation system 10 can be driven mainly by the prime mover during plant transients or periods of increased high pressure steam demand. During occasions of high prime mover operation cost, such as day-hours of higher electricity price, the vapor compressor load could be shifted to the high pressure steam expander. In yet another configuration, the vapor compressor load is shared between the high pressure steam expander and the prime mover.

The hybrid vapor compression drive assembly 18 (FIG. 1) disclosed herein can be realized in various ways. More particularly, the disclosed drive assembly may be constructed using positive displacement, reciprocating and rotating compressors and expanders. The disclosed drive assembly may also be realized using single or multi-stage compressors and expanders. Actual component construction may vary according to the needs of the membrane distillation system (pressure ratios, flow rates, etc.) As disclosed herein, the coupling between the drive assembly components may by mechanical or electrical. Couplings can be realized in various different ways, according to specific system requirements, and may be realized using, for example, chain drives, belts, hydraulic couplings and geared couplings. All suggested constructions can operate at variable shaft(s) speed(s) pursuing optimum system efficiency at variable load.

Referring more specifically to FIG. 2, illustrated in this particular embodiment is a hybrid vapor compression drive assembly 100, generally similar to the hybrid vapor compression drive assembly 18 of FIG. 1. In this particular embodiment, the hybrid vapor compression drive assembly 100 is configured as a single shaft hybrid system. The drive assembly 100 includes a vapor compressor 102, a steam expander 104 and a prime mover 106. In a preferred embodiment, the prime mover 106 is a gas turbine and the steam expander 104 is a high speed rotating machine. In another embodiment the prime mover 106 is a smaller speed machine, such as an electric motor or piston engine, coupled to an reciprocating steam expander 104. The vapor compressor 102, the steam expander 104 and the prime mover 106 are configured including a mechanical coupling 108, and more particularly configured to share a common drive shaft 110 and rotational speed.

An inlet 112 of the hybrid vapor compression drive assembly 100, and more particularly the vapor compressor 102, generally similar to inlet 42 of FIG. 1, is coupled to the MD module 12, and more particularly the first extreme vapor channel 26 (FIG. 1) for receiving an input flow of low pressure steam 46 from the MD module 12 (FIG. 1). In addition, an inlet 114 of the steam expander 104 is coupled to a source of high pressure steam, such as a boiler, for receiving an input flow of high pressure steam 66. An outlet 118 of the vapor compressor 102 and an outlet 120 of the steam expander 104, provide for the output of a compressed output flow 122 from the vapor compressor 102 and an expanded output flow 124 from the steam expander 104. In an embodiment, mixing of the compressed output flow 122 and the expanded output flow 124 provides an output flow of intermediate pressure steam 50 to the MD module 12. More particularly, outlets 118 and 120 are coupled to the second extreme vapor channel 40 (FIG. 1) for input of the output flow of intermediate pressure steam 50 to the MD module 12 (FIG. 1).

In an embodiment, during operation, the prime mover 106, and/or the input flow of high pressure steam 66, provide a driving force for the hybrid vapor compression drive assembly 100. More particularly, the prime mover 106 may provide a driving force to the vapor compressor 102 via the drive shaft 110. The drive shaft 110 may further provide a driving force to the compressor 102 from the steam expander 104 via the input of the flow of high pressure steam 66 to the vapor compressor 102. Accordingly, the load on the compressor 102 is shared between the prime mover 106 and the steam expander 104. As previously indicated, in installations that use high pressure steam for other purposes the membrane distillation system 12 (FIG. 1) may be driven mainly by the prime mover 106 during plant transients or periods of increased high pressure steam demand. During occasions of high prime mover operation cost, the vapor compressor load could be shifted to the high pressure steam expander 104. In this way the power required to drive the vapor compressor 102 can be shared between the prime mover 106 and steam expander 104 in ways that better suit overall plant operations.

Referring now to FIG. 3, illustrated in this particular embodiment is a hybrid vapor compression drive assembly 150, generally similar to the hybrid vapor compression drive assembly 18 of FIG. 1. In this particular embodiment, the hybrid vapor compression drive assembly 150 is configured as a one-speed ratio geared hybrid system, thus including a mechanical coupling. Similar to the previously described embodiment, the drive assembly 150 includes a vapor compressor 102, a steam expander 104 and a prime mover 106. In contrast to the previous embodiment, the vapor compressor 102, the steam expander 104 and the prime mover 106 are configured including a mechanical coupling 108, and more particularly configured to share a geared mechanical coupling 152 via a first drive shaft 154 and a second drive shaft 156. In an embodiment, the compressor 102 and the steam expander 104 are configured to share the second drive shaft 156 and rotational speed. The prime mover 106 may operate at variable speed. In a preferred embodiment, the prime mover 106 is a lower speed prime mover, such an electrical motor or internal combustion engine.

An inlet 112 of the hybrid vapor compression drive assembly 150, and more particularly the vapor compressor 102, generally similar to inlet 42 of FIG. 1, is coupled to the MD module 12, and more particularly the first extreme vapor channel 26 (FIG. 1) for receiving an input flow of low pressure steam 46 from the MD module 12 (FIG. 1). In addition, an inlet 114 of the steam expander 104 is coupled to a source of high pressure steam, such as a boiler, for receiving the input flow of high pressure steam 66. An outlet 118 of the vapor compressor 102 and an outlet 120 of the steam expander 104, provide for the output of a compressed output flow 122 from the vapor compressor 102 and an expanded output flow 124 from the steam expander 104. Mixing of the compressed output flow 122 and the expanded output flow 124 provides an output flow of intermediate pressure steam 50 to the MD module 12. More particularly, outlets 118 and 120 are coupled to the second extreme vapor channel 40 (FIG. 1) for the input of the output flow of intermediate pressure steam 50 to the MD module 12 (FIG. 1).

During operation, the prime mover 106 and/or the input flow of high pressure steam 66 provides a driving force for the hybrid vapor compression drive assembly 150. More particularly, the prime mover 106 provides a driving force via the first drive shaft 154 to the one-speed ratio geared coupling 152. In an embodiment, the one-speed ratio geared coupling 152 includes a first rotating component 158 and a second rotating component 160. The geared coupling 152 provides rotational movement of the second drive shaft 156 in response to the force exerted by the prime mover 106. The rotational movement of the geared coupling 152 thereby transferring the driving force from the prime mover 106 to the compressor 102 and the steam expander 104 via the second drive shaft 156. The geared coupling 152 may further provide a driving force from the steam expander 104 via the input of the flow of high pressure steam 66 to the vapor compressor 102. Accordingly, the load on the compressor 102 is shared between the prime mover 106 and the steam expander 104. As previously indicated, in installations that use high pressure steam for other purposes the membrane distillation system 12 (FIG. 1) may be driven mainly by the prime mover 106 during plant transients or periods of increased high pressure steam demand. During occasions of high prime mover operation cost, the vapor compressor load could be shifted to the high pressure steam expander 104. The total power required to drive the vapor compressor 102 can be shared between the prime mover 106 and steam expander 104 in ways that better suit overall plant operations.

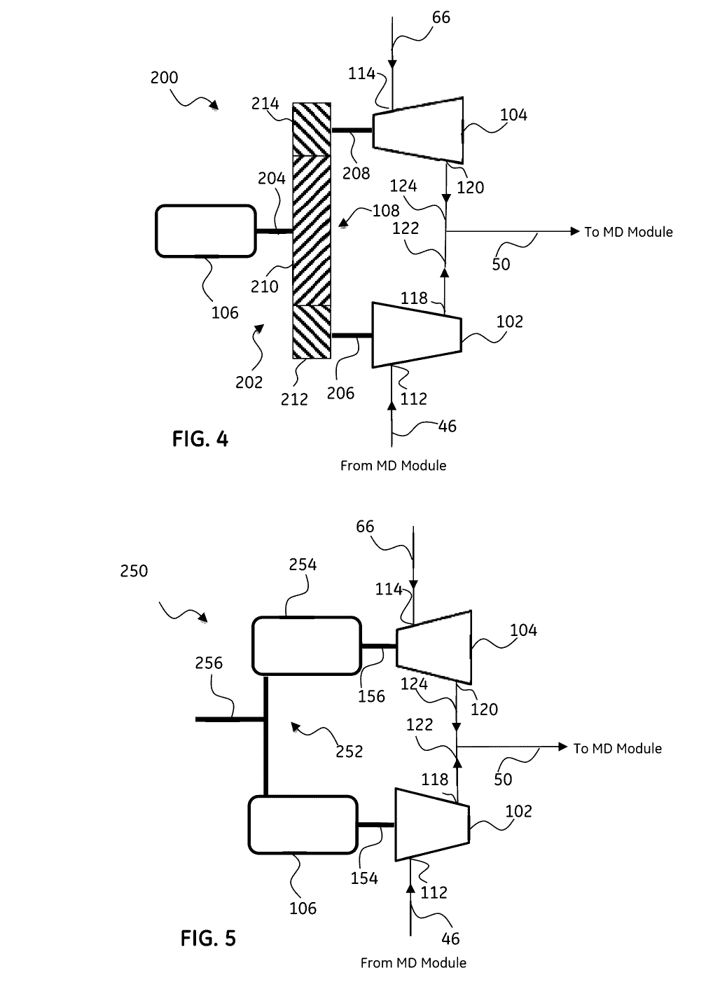

Referring now to FIG. 4, illustrated in this particular embodiment is a hybrid vapor compression drive assembly 200, generally similar to the hybrid vapor compression drive assembly 18 of FIG. 1 and the hybrid vapor compression drive assembly 150 of FIG. 3. In this particular embodiment, the hybrid vapor compression drive assembly 200 is configured as a two-speed ratio geared hybrid system, thus including a mechanical coupling. Similar to the previously described embodiment of FIG. 3, the drive assembly 200 includes a vapor compressor 102, a steam expander 104 and a prime mover 106. The vapor compressor 102, the steam expander 104 and the prime mover 106 are configured including a mechanical coupling 108, and more particularly configured to share a geared coupling 202 via a first drive shaft 204, a second drive shaft 206 and a third drive shaft 208. More particularly, the prime mover 106 is coupled to the vapor compressor 102 via the first drive shaft 204, the geared coupling 202 and the second drive shaft 206. The prime mover 106 is additionally coupled to the steam expander 104 via the first drive shaft 204, the geared coupling 202 and the third drive shaft 208. The coupling of the prime mover 106, the compressor 102 and the steam expander 104 as described, permits operation of each component at a different rotational speed. This embodiment of the hybrid vapor compression drive assembly 200 may find best utility in systems that use both rotating and reciprocating machines for vapor compression and steam expansion. In a preferred embodiment, the prime mover 106 is a lower speed prime mover, such an electrical motor or internal combustion engine.

An inlet 112 of the hybrid vapor compression drive assembly 200, and more particularly the vapor compressor 102, generally similar to inlet 42 of FIG. 1, is coupled to the MD module 12, and more particularly the first extreme vapor channel 26 (FIG. 1) for receiving an input flow of low pressure steam 46 from the MD module 12 (FIG. 1). In addition, an inlet 114 of the steam expander 104 is coupled to a source of high pressure steam, such as a boiler, for receiving the input flow of high pressure steam 66. An outlet 118 of the vapor compressor 102 and an outlet 120 of the steam expander 104, provide for the output of a compressed output flow 122 from the vapor compressor 102 and an expanded output flow 124 from the steam expander 104. Mixing of the compressed output flow 122 and the expanded output flow 124 provides an output flow of intermediate pressure steam 50 to the MD module 12. More particularly, outlets 118 and 120 are coupled to the second extreme vapor channel 40 (FIG. 1) for the input of the output flow of intermediate pressure steam 50 to the MD module 12 (FIG. 1).

During operation, the prime mover 106 and/or the input flow of high pressure steam 66 provides a driving force for the hybrid vapor compression drive assembly 200. More particularly, the prime mover 106 provides a driving force via the first drive shaft 204 to the two-speed ratio geared coupling 202. In an embodiment, the two-speed ratio geared coupling includes a first rotating gear component 210, a second rotating gear component 212 and a third rotating gear component 214. In response to a force exerted by the prime mover 106, the first drive shaft 204 is rotated and provides rotational movement of the geared coupling 202, and more particularly the first rotating component 210, with transfer of the rotation to the second rotating component 212 and third rotating component 214. More particularly, the geared coupling 202 provides transfer of the driving force from the prime mover 106 to the compressor 102 via the rotating components 210 and 212 and the second drive shaft 206. The geared coupling 202 further provides transfer of the driving force from the prime mover 106 to the steam expander 104 via the rotating components 210 and 214 and the third drive shaft 208. The geared coupling 202 may further provide a driving force from the steam expander 104 via the input of the flow of high pressure steam 66 to the vapor compressor 102. Accordingly, the load on the compressor 102 is shared between the prime mover 106 and the steam expander 104. As previously indicated, in installations that use high pressure steam for other purposes the membrane distillation system 12 (FIG. 1) may be driven mainly by the prime mover 106 during plant transients or periods of increased high pressure steam demand. During occasions of high prime mover operation cost, the vapor compressor load could be shifted to the high pressure steam expander 104. The total power required to drive the vapor compressor 102 can be shared between the prime mover 106 and steam expander 104 in ways that better suit overall plant operations. The compressor 102 rotational speed may be variable according to operational convenience. In this scenario, because of the geared coupling, the prime mover 106 and steam expander 104 would also operate at variable rotational speeds.

Referring now to FIG. 5, illustrated in this particular embodiment is a hybrid vapor compression drive assembly 250, generally similar to the hybrid vapor compression drive assembly 18 of FIG. 1. In this particular embodiment, the hybrid vapor compression drive assembly 250 is configured to include an electrical coupling 252 between the drive components. Similar to the previously described embodiments, the drive assembly 250 includes a vapor compressor 102, a steam expander 104 and a prime mover 106. In addition, the hybrid vapor compression drive assembly 250 includes a generator 254 coupled to the steam expander 104 and an electrical input/output 256. In this particular embodiment, the compressor load is partially or totally supplied by the generator 254, operating in parallel to the electrical grid, and more particularly the electrical input/output 256. Varying the output of the generator 254 and associated high pressure steam consumption by the steam expander 104, provides a shifting of the compressor energy usage between the input flow of high pressure steam 66 and the electrical input/output 256. In an alternate embodiment wherein the system is not connected to the electrical input/output 256, input to the hybrid vapor compression drive assembly 250 may be supplied by one or more local generators.

In this particular embodiment, the electrical input/output 256 is coupled to the prime mover 106 and the generator 254 and configured to provide electrical energy thereto. The prime mover 106 is coupled to the vapor compressor 102 via a first drive shaft 154. The generator 254 is coupled to the steam expander 104 via a second drive shaft 156. The coupling of the prime mover 106, the compressor 102 and the steam expander 104 as described, permits operation of each at different rotational speeds. The hybrid vapor compression drive assembly 250 may best find utility in systems that use rotating and/or reciprocating machines for vapor compression and steam expansion. In a preferred embodiment, the prime mover 106 is a lower speed prime mover, such an electrical motor.

An inlet 112 of the hybrid vapor compression drive assembly 250, and more particularly the vapor compressor 102, generally similar to inlet 42 of FIG. 1, is coupled to the MD module 12, and more particularly the first extreme vapor channel 26 (FIG. 1) for receiving an input flow of low pressure steam 46 from the MD module 12 (FIG. 1). In addition, an inlet 114 of the steam expander 104 is coupled to a source of high pressure steam, such as a boiler, for receiving the input flow of high pressure steam 66. An outlet 118 of the vapor compressor 102 and an outlet 120 of the steam expander 104, provide for the output of a compressed output flow 122 from the vapor compressor 102 and an expanded output flow 124 from the steam expander 104. Mixing of the compressed output flow 122 and the expanded output flow 124 provides an output flow of intermediate pressure steam 50 to the MD module 12. More particularly, outlets 118 and 120 are coupled to the second extreme vapor channel 40 (FIG. 1) for the input of the output flow of intermediate pressure steam 50 to the MD module 12 (FIG. 1).

During operation, the prime mover 106 and/or the input flow of high pressure steam 66, provides a driving force via the electrical input/output 256 and/or the generator 254 for the hybrid vapor compression drive assembly 250. More particularly, the prime mover 106 provides a driving force via the first drive shaft 154 to the compressor 102. The first drive shaft 154 provides transfer of the driving force from the prime mover 106 to the compressor 102 via the rotating first drive shaft 154. The second drive shaft 156 provides transfer of a driving force from the steam expander 104 to the generator 254 via the rotating second drive shaft 156. Accordingly, the load on the compressor 102 is shared between the prime mover 106, the generator 254 and the steam expander 104. As previously indicated, in installations that use high pressure steam for other purposes the membrane distillation system 12 (FIG. 1) may be driven by the prime mover 106, mainly through usage of energy drawn from the electrical power input 256, during plant transients or periods of increased high pressure steam demand. During occasions of high cost for the energy available at the electrical power input 256, the vapor compressor load can be shifted to the high pressure steam expander 104 and generator 254. The total power required to drive the vapor compressor 102 can be shared between the electrical power input 256 and steam expander 104 in ways that better suit overall plant operations.

Accordingly, disclosed is a membrane distillation system, and more particularly a hybrid vapor compression drive assembly for a membrane distillation system that utilizes vapor compression and distributes the membrane compressor load between a steam expander and a prime mover. The hybrid vapor compression drive assembly disclosed herein has an advantage over conventional mechanically driven membrane distillation systems, in that the system provides maximum energy efficiency and increases the operating flexibility of the membrane distillation system. In particular, the hybrid vapor compression drive assembly provides operation at an optimized operational expenditure (commercial advantage) and better suits overall plant energy usage. In one particular instance, the system allows for steam boilers optimum usage in sites that also use steam for other purposes different from membrane distillation, alleviates the need for investments in increased steam boiler capacity in sites that already have steam generating capacity in place and consider adding membrane distillation to their processes, and allows for reduced energy costs as the vapor compressor load of membrane distillation systems may be shifted to a more convenient cost energy source as energy rates vary over relatively short periods of time, often hours.

A further advantage of the disclosed membrane distillation system, and more particularly the hybrid vapor compression drive assembly for a membrane distillation system, can be found in the higher relative yield of the MD stages. As fewer temperature and pressure stages are required, these stages can be significantly larger in comparison to a pure thermal system. The resulting higher average steam temperature and therefore density results in lower pressure losses and higher average flux than would be expected in a system that spans a wider temperature range. In addition, the requirements for heat sinking are significantly reduced, as the vapor emanating from the final stage is not condensed at a lower temperature, but instead fed back into the high temperature stage of the system.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A hybrid vapor compression membrane distillation drive assembly comprising:
a vapor compressor configured to receive an input flow of low pressure steam and produce a compressed output flow;
a steam expander configured to receive an input flow of high pressure steam, having a pressure greater than the low pressure steam, and produce an expanded output flow, wherein the compressed output flow and the expanded output flow provide an output flow of intermediate pressure steam; and
a prime mover coupled to the vapor compressor,
wherein a total vapor compressor load is shared between the steam expander and the prime mover.

2. The hybrid vapor compression membrane distillation drive assembly as claimed in claim 1, wherein the prime mover is one or more of a gas turbine engine, an electrical motor and an internal combustion engine.

3. The hybrid vapor compression membrane distillation drive assembly as claimed in claim 1, wherein the prime mover is further coupled to the steam expander.

4. The hybrid vapor compression membrane distillation drive assembly as claimed in claim 3, wherein the prime mover is coupled to the vapor compressor and the steam expander by a mechanical coupling.

5. The hybrid vapor compression membrane distillation drive assembly as claimed in claim 4, wherein the mechanical coupling includes one of a chain drive, a belt coupling, a hydraulic coupling or a geared coupling.

6. The hybrid vapor compression membrane distillation drive assembly as claimed in claim 1, wherein the prime mover is coupled to the vapor compressor by an electrical coupling.

7. The hybrid vapor compression membrane distillation drive assembly as claimed in claim 1, further comprising a generator, wherein the generator is coupled to the steam expander and the prime mover and provides a varying electrical input to the prime mover.

8. A membrane distillation system comprising:
a membrane distillation module; and
a hybrid vapor compression drive assembly in fluidic communication with the membrane distillation module and configured to introduce an output flow of intermediate pressure steam to a high temperature side of the membrane distillation module and receive an input flow of low pressure steam, having a pressure less than the intermediate pressure steam, from a low temperature side of the membrane distillation module, thereby creating a temperature gradient across of the membrane distillation module, the hybrid vapor compression drive assembly comprising:
a vapor compressor configured to receive the input flow of low pressure steam and produce a compressed output flow;
a steam expander configured to receive an input flow of high pressure steam, having a pressure greater than the low pressure steam, and produce an expanded output flow, wherein the compressed output flow and the expanded output flow provide the output flow of intermediate pressure steam; and
a prime mover coupled to the vapor compressor,
wherein a total vapor compressor load is shared between the steam expander and the prime mover.

9. The membrane distillation system as claimed in claim 8, wherein the membrane distillation module further comprises a plurality of membrane distillation membranes interleaved with a plurality of heat transfer films, the plurality of membrane distillation membranes and the plurality of heat transfer films configured spaced apart to define a plurality of channels therebetween.

10. The membrane distillation system as claimed in claim 9, further comprising a plurality of liquid flow channels each bounded by a membrane distillation membrane and a heat transfer film.

11. The membrane distillation system as claimed in claim 8, further comprising a first extreme vapor flow channel formed between and bounded by a membrane distillation membrane and a surface of the object into which the membrane distillation module is disposed and a second extreme vapor flow channel formed between and bounded by a heat transfer film and a surface of the object into which the membrane distillation module is disposed.

12. The membrane distillation system as claimed in claim 8, wherein the hybrid vapor compression drive assembly further comprises:
an inlet coupled to the first extreme vapor flow channel, the inlet configured to receive the input flow of low pressure steam; and
an outlet coupled to the second extreme vapor flow channel, the outlet configured to discharge the output flow of intermediate pressure steam.

13. The membrane distillation system as claimed in claim 8, wherein the prime mover is one or more of a gas turbine engine, an electrical motor and an internal combustion engine.

14. The membrane distillation system as claimed in claim 8, wherein the prime mover is coupled to the vapor compressor and the steam expander by a mechanical geared coupling.

15. The membrane distillation system as claimed in claim 8, wherein the prime mover is coupled to the vapor compressor by an electrical coupling.

16. The membrane distillation system as claimed in claim 8, further comprising a generator, wherein the generator is coupled to the steam expander and the prime mover and provides a varying electrical input to the prime mover.

17. A method of driving a membrane distillation system comprising:
supplying an unpurified fluid in an input feed stream;
providing a membrane distillation module disposed within an object and configured to receive the input feed stream and produce an output product flow stream;
supplying a hybrid vapor compression membrane distillation drive assembly in fluidic communication with the membrane distillation module, the hybrid vapor compression membrane distillation drive assembly comprising a vapor compressor configured to receive an input flow of low pressure steam from a low temperature side of the membrane distillation module, a steam expander configured to receive an input flow of high pressure steam, having a pressure greater than the low pressure steam, and a prime mover coupled to the vapor compressor;
passing the input feed stream through the membrane distillation module as a flow stream while withdrawing the input flow of low pressure steam;
at least one of compressing the input flow of low pressure steam in a vapor compressor of the hybrid vapor compression membrane distillation drive assembly to produce a compressed output flow and expanding the input flow of high pressure steam in a steam expander of the hybrid vapor compression membrane distillation drive assembly, wherein the input flow of high pressure steam is of a pressure greater than the input flow of low pressure steam, to produce an expanded output flow, wherein the compressed output flow and the expanded output flow provide an output flow of intermediate pressure steam having a pressure greater than the input flow of low pressure steam; and
introducing the output flow of intermediate pressure steam to a high temperature side of the membrane distillation module, thereby creating a temperature gradient across of the MD module,
wherein a total load to the vapor compressor of the hybrid vapor compression membrane distillation drive assembly is shared between the steam expander and the prime mover.

18. The method as claimed in claim 17, wherein the prime mover is one or more of a gas turbine engine, an electrical motor and an internal combustion engine.

19. The method as claimed in claim 17, wherein the prime mover is coupled to the vapor compressor and the steam expander by a mechanical coupling.

20. The method as claimed in claim 17, wherein the prime mover is coupled to the vapor compressor and a generator by an electrical coupling.
